(19) United States
(12) Patent Application Publication
(10) Pub. No.: US 2011/0271591 A1
(43) Pub. Date: Nov. 10, 2011

(54) METHOD FOR MAINTAINING PLANTS

(76) Inventors: Charles F. Walton, Hudson, OH (US); Garry Legnani, Kent, OH (US)

(21) Appl. No.: 12/774,800

(22) Filed: May 6, 2010

(51) Int. Cl. A01G 9/02

(52) U.S. Cl. 47/66.7; 47/65.5; 47/79

(57) ABSTRACT

A storage device for maintaining potted plant viability and quality that allows for sufficient water or other suitable liquid to roots and growing media of a plant. The device includes a storage pot having a base and walls, a foam insert disposed within the storage pot; and the insert having a lower surface that engages the base and a flat upper surface where the root mass and growing media are placed. The root mass and growing media maintains its position by engaging the upper flat surface of the foam and at least one of the walls of the pot. A method is also disclosed for transporting or storage that includes potting a plant in the storage pot, and wetting the foam insert.

### FIELD OF THE INVENTION

The present invention generally relates to a method for maintaining the viability of plants. More particularly, it relates to a method for maintaining a potted plant during transportation and retail sale.

### BACKGROUND OF THE INVENTION

Potted plants are typically grown at a greenhouse and then may be transported to a retail store for resale to the general public. Upon delivery, plants may remain at retail stores for varying durations, and therefore, require sufficient moisture to maintain viability. Typically, these potted plants are shipped in the same pot in which the plant was propagated. For growing plants, greenhouses may employ capillary mats that are placed on the surface of greenhouse benches, and then potted plants are placed thereon. The plants are watered, and the excess water drains through the pots' drain holes and is absorbed by the capillary mat. As the plant requires additional water, the water wicks through the drain holes and is supplied to the plant. Although useful, due to various constraints, such as a lack of watering capabilities at other sites, this approach is limited primarily to the greenhouse environment and is not suitable for transportation or storage at retail stores.

Plants require sufficient irrigation for proper growth and development; however, potted plants may experience intervals of significant water stress during shipping and retail display due to a lack of watering capabilities. Furthermore, many persons who transport or sell plants are not trained horticulturalists, and may either under water or over water the plant, resulting in poor quality. Accordingly, there is a need for an easy, inexpensive method to provide sufficient water to potted plants during transport and retail display.

It is known to utilize water absorbing foam or other materials to provide a reservoir for potted plants. However, these systems utilize a reservoir material that is external to an open-bottomed pot or a pot whose bottom surface is perforated with a series of drain holes that allow for the wicking of water or other suitable liquid from the reservoir material to the root-zone. Although beneficial, this system can prove to be messy as potting media can escape from the bottom of the pot during the culture, transportation, and retail display of the potted plant.

Another method that is utilized is the use of a wicking paper that surrounds the surface of the root-zone and growing media. This requires additional materials, and therefore, may add to the cost of the plant. Moreover, it is possible that the wicking paper may be damaged, torn or dislodged during transportation of the plant such that the plant does not receive the proper amount of water. Thus, the need exists for a transportation or storage pot that does not require constant watering and does not employ wicking paper.

Another known method in the art for maintaining plants is to provide a water tight pot that includes a foam material that conforms to the shape of the pot and displaces a certain volume of growing media. Although useful, the device displaces a significant amount of growing media and requires the plant roots to penetrate the foam to access available water and air. Because of this, growers may have to significantly alter their traditional cultural methods to grow quality plants. Furthermore, because the system requires the roots to penetrate the foam, cultural challenges such as a perched water table may arise when the consumer transplants the potted plant into the landscape or garden. Accordingly, there is a need for a system in which water absorbing foam is placed inside a pot without displacing the growing media and not requiring the roots to penetrate the foam, whereby the plant root-zone and growing media can be easily separated from the foam and transplanted in the landscape or garden without complication.

Thus, a need exists in the art for a pot containing a water absorbing foam insert therein that provides adequate water to a potted plant during transportation and retail display. Furthermore, there is a need to provide a method for maintaining plants, where the method includes removing the plant and root mass from its growing container and placing it in a storage container that includes a water absorbing foam insert that provides an additional reservoir of water or other suitable liquid without displacing growing media volume. Such a system would not require the grower to adjust their cultural methods when growing the plants and would help maintain plant viability during transportation and retail display.

### SUMMARY OF THE INVENTION

One or more of the foregoing aspects of the present invention, together with the advantages thereof over the known art relating to maintaining plants and methods thereof, which shall become apparent from the specification and drawings that follows, are accomplished by the invention as hereinafter described and claimed.

The present invention provides a plant storage device that includes a storage pot having a base and at least one wall extending upwardly from the base. The storage device further includes a foam insert having a flat upper surface and a lower surface disposed within the storage pot. The lower surface of the foam insert contacts the base within the storage pot and the wall of the storage pot extends above the foam insert a sufficient distance to maintain any growing media and roots of any stored plant within the storage pot against the wall of the storage pot.

The present invention further provides a device for supporting and maintaining a sufficient amount of water or other suitable liquid to roots and growing media of a plant. The device includes a storage pot having a base and at least one wall. A water absorbing foam insert having an upper surface and a lower surface is placed against the base of the storage pot. The foam insert includes a liquid disposed therein. The roots and growing media of the plant are positioned entirely above the foam insert within the storage pot such that liquid disposed in the foam insert is wicked to the root-zone and growing media for maintaining the viability of the plant.

The present invention still further provides a method for storing a plant during transportation or storage for sale. The method includes providing a storage pot having a base and at least one wall. A foam insert is disposed within the storage pot and contacts the base, and the wall extends above the foam insert. The method further includes wetting the foam insert, potting a plant having roots and growing media into the storage pot so that the roots and growing media are positioned entirely above the foam insert and contact at least one wall such that the roots and growing media of the plant are maintained inside the storage pot by the wall. The life of the plant is maintained by allowing the liquid in the foam insert to be wicked to the roots and growing media within the storage pot.

### BRIEF DESCRIPTION OF THE DRAWINGS

FIG. 1 is a cross-sectional view of a plant supported by a floral foam insert and walls of a storage pot; and

FIG. 2 is a cross-sectional view of a plant supported by a floral foam insert and walls of the storage pot of FIG. 1 further including an external reservoir.

### DETAILED DESCRIPTION OF THE ILLUSTRATIVE EMBODIMENTS

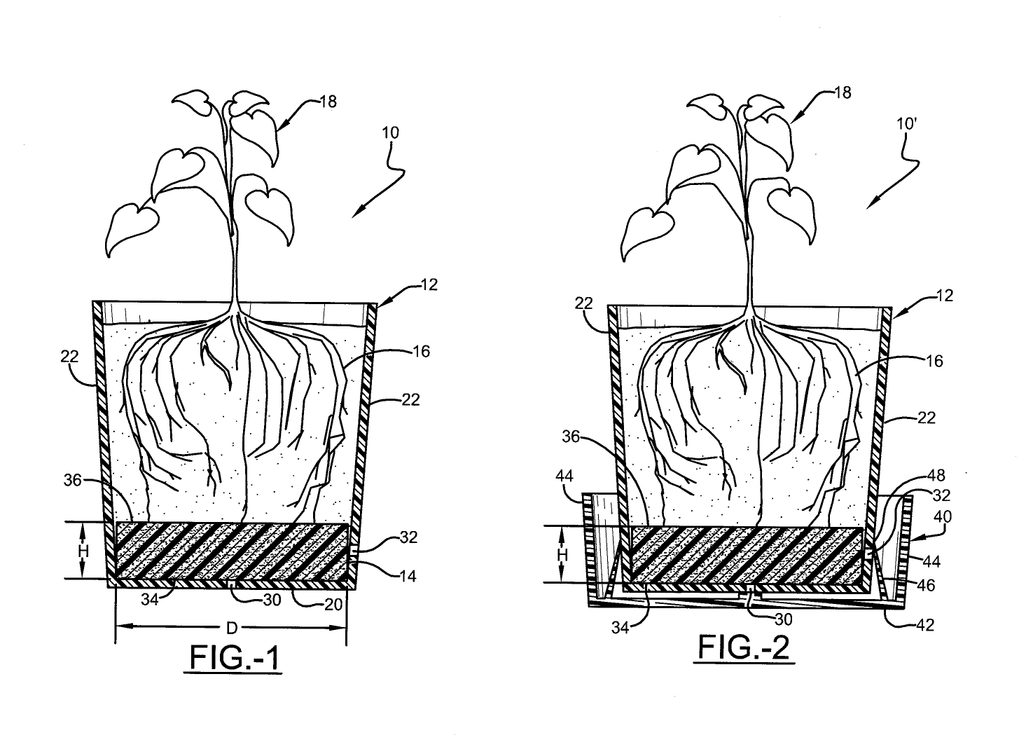

Referring now to FIGS. 1-2, a storage device that allows for sufficient wetting is depicted as numeral 10 and includes a storage pot 12 and an insert 14 of foam to contact directly with roots and growing media 16 of a plant 18.

Storage pot 12 may be constructed of any material readily known in the art. Preferably, storage pot 12 is made of plastic or other light weight material suitable for storing and transporting plants. As shown, storage pot 12 is constructed in the shape of a standard planter pot. However, the pot may be any shape that is readily known in the art that is suitable for receiving the root system and growing media 16 of plant 18. Storage pot 12 includes a base 20 and at least one wall 22 extending upwardly from base 20. Importantly, wall 22 extends above insert 14 a distance sufficient to maintain the growing media and roots 16 of plant 18 within the storage pot 12. The wall 22 supports the growing media and roots 16 along with the rest of plant 18 in an upright position. Wall 22 may include a design or may be decorated with decorative paper film or foil (not shown).

In one embodiment, storage pot 12 is a water-tight construction. In another embodiment, storage pot 12 may include hole(s) 30 located on base 20. In yet another embodiment, storage pot 12 may include hole(s) 32 located on the wall 22 proximate to the base 20 and within the height of insert 14, which will be discussed herein. In still further embodiments, storage pot 12 may include hole(s) 30, 32 on both the base 20 and wall 22, respectively.

Insert 14 is constructed of open-celled phenolic floral foam that is readily known in the art. Preferably, insert 14 is the Oasis® brand floral foam, which is described in U.S. Pat. No. 2,753,277, the description of which is incorporated herein by reference. The use of this foam allows water to be distributed to roots and growing media 16 of plant 18 through capillary action. As shown in FIG. 2, insert 14 is cylindrically shaped having a height H, which is less than the height of wall 22. Insert 14 also has a diameter D, which is less the diameter of the base 20. It should be noted that insert 14 has a lower surface 34 that rests against the base 20 of storage pot 12, and an upper surface 36 that provides a flat resting surface to support the roots and growing media 16. In one embodiment, upper surface 36 is devoid of any cavities or other protrusions. Roots and growing media 16 are placed against upper surface 36 and against wall 22 of storage pot 12 to maintain the plant's upright position. Insert 14 may also of any geometry that allows insert 14 to rest against base 20 of storage pot 12. In one embodiment, disk 14 is circular or cylindrical. In another embodiment, insert 14 is rectangular.

In embodiments that include hole(s) 30, 32, excess liquid may escape or additional liquid outside of storage pot 12 may be absorbed by the insert 14 through the holes 30, 32. These embodiments may also include a reservoir 40 that catches excess liquid from, or provide additional liquid through, hole(s) 30, 32. In the embodiment shown reservoir 40 is depicted as a bowl-like apparatus having a base portion 42 and an annular sidewall 44 that extends upwardly therefrom. Reservoir 40 can be any device readily available in the art. However, when storage pot 12 includes hole(s) 32 on its wall, annular sidewall 44 has a height greater than hole(s) 32 to allow liquid to be received by reservoir. This structural embodiment also allows excess liquid to be wicked through hole 32.

Reservoir 40 also may include retainers 46 that extend upwardly proximate to the central area of base portion 42. Retainers 46 are flexible and provide a holding surface 48 that engages the walls 22 of storage pot 12. As storage pot 12 is placed into reservoir 40, each retainer 46 expands outwardly from the pot and then returns back to secure pot into position. Any other suitable methods readily available in the art to secure pot 12 to reservoir 40 may also be employed.

In light of the above device, the following method is contemplated for maintaining potted plant viability during transportation and retail display. Once the plant has grown to the point where roots and growing media 16 are present, it is beneficial to employ the following steps which use storage pot 12 and insert 14.

It will be understood that a method for maintaining plant viability during transportation and retail display can be achieved. One method for using the storage device 10 described above will now be discussed. The method includes providing a storage pot 12. The storage pot 12, as described above, includes a base 20 and at least one wall 22. In certain embodiments, the method includes providing a storage pot 12 that has at least one hole 30 or 32 as shown in FIG. 2.

The method includes providing foam insert 14, which is sized such that it may be completely disposed within the storage pot 12 as shown in the figures. The user installs the foam insert 14 within the storage pot 12 by placing the insert 14 onto the base 20 so that wall 22 of storage pot 12 extends above the foam insert 14.

The user wets the foam insert 14 with water or any other suitable liquid. Wetting the foam insert 14 may occur at any time and may be accomplished by pouring liquid directly onto the insert 14 or alternatively though absorbing excess water from liquid that was supplied directly to the roots and growing media 16 of plant 18. In embodiments in which the storage pot 12 includes at least one hole 30 or 32, the user may optionally supply liquid through the hole 30 or 32.

After the insert 14 has been installed, the user pots plant 18 having roots and growing media 16 into the storage pot 12. It should be understood that the roots and growing media 16 of plant 18 can be either removed from the ground or from a separate growing pot (not shown). The user positions the roots and growing media 16 entirely above the foam insert 14 and against at least one wall 22. This allows the plant 18 to keep an upright position and also allows the roots and growing media 16 to be maintained inside the storage pot by the at least one wall 22. Preferably, the roots and growing media 16 are placed within the storage pot 12 devoid of any wicking paper.

Optionally, the method may further provide a reservoir 40, which is further described above, having a base 42 and upwardly extending sides 44. The reservoir 40 may be used when the storage pot 12 includes at least one hole 30 or 32, but may also be used when water-tight storage pots are employed. It also should be apparent that reservoir may be adapted to receive more than one storage pots 12. For methods that include use of a reservoir 40, the user simply places the storage pot 12 within the reservoir 40. In certain embodiments, the method includes providing a reservoir 40 that securely maintains the position of the storage pot 12. One method includes providing flexible retainers 46 that receive the walls 22 of storage pot 12.

The reservoir 40 adds additional versatility with respect to supplying moisture to the plant, because the user can add liquid to the reservoir 40 so that it surrounds hole(s) 30 or 32, which allows the foam insert 14 to absorb the liquid through the hole(s) 30 or 32. Also, it should be appreciated that the reservoir catches any excess liquid that may flow over the walls 22 or out of hole(s) 30, 32.

As a result of this method, the user maintains the viability of the plant 18 without the need for constant watering by allowing the liquid in the foam insert 14 to be wicked to the roots and growing media 16 within the storage pot 12

As a result, the life of the plant may be maintained for an extended period of time. It will be appreciated that the actual life of the plant will depend on several factors in addition to water supply, including light levels, humidity, nutrition, and plant type. It will be appreciated that the method of the present invention allows for water or other suitable liquid to be absorbed and stored within insert 14 so as to be available to the root-zone and growing media 16 within the storage pot 12 as needed to maintain viability of the plant.

In addition to the steps above, the storage pot 12 may include any number of hole(s) 30, 32 that allow excess liquid to drain out of the storage pot 12, and allow additional liquid to be absorbed by the insert 14. In one embodiment, liquid can be added to the pot through one hole 32 in the side of the pot. In another embodiment, no bottom hole(s) 30 is present in the pot.

From the forgoing, it should be clear that the present invention provides a significant improvement in maintaining plants. It is understood that the drawings just show one example, provided merely as practical demonstration of the invention, it being possible for the invention to vary in the shapes and arrangements without on the other hand departing from the scope of the idea underlying the invention itself. Furthermore, although the description focuses primarily on the use of plants, the above methods also apply to plants that are transplanted from the ground. As such, the claims that follow shall serve to define the scope of the invention.

What is claimed is:

1. A plant storage device comprising:
a storage pot having a base and at least one wall extending upwardly from the base; and
a foam insert having a flat upper surface and a lower surface disposed within the storage pot, wherein the lower surface of the foam insert contacts the base within the storage pot and wherein the at least one wall of the storage pot extends above the foam insert a sufficient distance to maintain any growing media and roots of any stored plant within the storage pot against the at least one wall of the storage pot.

2. The device of claim 1, wherein the storage pot includes at least one hole.

3. The device of claim 2, wherein the at least one hole is located on the wall.

4. The device of claim 1, wherein the foam insert is a first height, and the at least one wall includes a hole at a second height that is lower than the first height.

5. The device of claim 4, further comprising a reservoir adapted to receive the storage pot and having sides that extend therefrom at third height greater than the second height to allow liquid to reenter through the hole.

6. The device of claim 5, the reservoir further comprising ribs that extend upwardly from the reservoir that are adapted to engage the walls of the storage pot to maintain the storage pot in a fixed position.

7. The plant storage device of claim 1, wherein the device is devoid of wicking paper.

8. A device for supporting and maintaining a sufficient amount of liquid to roots and growing media of a plant, the device comprising:
a storage pot having a base and at least one wall; and
a foam insert having an upper surface and a lower surface disposed within the storage pot and contacting the base; the foam insert having liquid disposed therein, wherein the roots and growing media of the plant are positioned entirely above the foam insert within the storage pot such that liquid disposed in the foam insert is wicked to the roots and growing media for maintaining the life of the plant.

9. The device of claim 8, wherein the storage pot includes at least one hole.

10. The device of claim 9, wherein the hole is located on the wall.

11. The device of claim 8, wherein the foam is a first height, and the at least one wall includes a hole at a second height that is lower than the first height.

12. The device of claim 11, further comprising a reservoir adapted to receive the storage pot and having sides that extend therefrom at a height greater than the second height to allow liquid to reenter through the hole.

13. The device of claim 12, the reservoir further comprising ribs that extend upwardly from the reservoir that are adapted to engage the walls of the storage pot to maintain the storage pot in a fixed position.

14. The plant storage device of claim 8, wherein the device is devoid of wicking paper.

15. A method for storing a plant during transportation or storage for sale, the method comprising:
providing a storage pot having a base and at least one wall, wherein a foam insert is disposed within the storage pot and contacts the base, and wherein the at least one wall extends above the foam insert;
wetting the foam insert;
potting a plant having roots and growing media into the storage pot, wherein the roots and growing media are positioned entirely above the foam insert and contact at least one wall such that the roots and growing media of the plant are maintained inside the storage pot by the at least one wall; and
maintaining the life of the plant without wetting it by allowing the water or other suitable liquid in the foam insert to be wicked to the root-zone and growing media within the storage pot.

16. The method of claim 15, wherein the storage pot further comprises at least one hole and the method further comprising the steps of:
providing a reservoir having a base and upwardly extending sides; and
placing the storage pot within the reservoir.

17. The method of claim 16, wherein the step of wetting the foam insert comprises:
adding liquid to the reservoir such that the hole is surrounded by the liquid, and wherein the foam insert absorbs the liquid through the hole.

18. The method of claim 15, wherein the step of potting the plant comprises:
removing the plant from a growing pot, and inserting the root mass and growing media into the storage pot devoid of any wicking paper.

19. The method of claim 15, wherein the step of wetting the foam insert comprises:
adding water or other suitable liquid to the roots and growing media so that a portion of the liquid is absorbed by the foam insert.
